(19) United States
(12) Patent Application Publication
(10) Pub. No.: US 2017/0110253 A1
(43) Pub. Date: Apr. 20, 2017

(54) Electrolyte Solution for Aluminum Electrolytic Capacitor and Aluminum Electrolytic Capacitor Using the Electrolyte Solution

(71) Applicant: SHENZHEN CAPCHEM TECHNOLOGY CO., LTD., Shenzhen, Guangdong (CN)

(72) Inventors: Yang Liu, Shenzhen, Guangdong (CN); Mingjie Wang, Shenzhen, Guangdong (CN)

(21) Appl. No.: 15/038,041

(22) PCT Filed: Sep. 8, 2015
(86) PCT No.: PCT/CN2015/089166

§ 371 Date: May 19, 2016

(30) Foreign Application Priority Data
May 4, 2015 (CN) 201510221424.5

(51) Int. Cl. H01G 9/035; H01G 11/62; H01G 9/045; H01G 9/145

(52) U.S. Cl. CPC H01G 9/035; H01G 9/145; H01G 11/62; H01G 9/045

(57) ABSTRACT

The present invention discloses an electrolyte solution for an aluminum electrolytic capacitor and an aluminum electrolytic capacitor using the electrolyte solution. The electrolyte solution for an aluminum electrolytic capacitor, contains electrolyte (A) and an organic solvent (B); the electrolyte (A) contains electrolyte (C) and electrolyte (D); the electrolyte (C) consists of cations (E) and alkyl phosphate anions, and the electrolyte (D) consists of cations (F) and phthalic acid anions. The electrolyte solution of the present invention can obtain high specific conductivity and sparking voltage, and can realize aluminum electrolytic capacitor without a risk of corrosion of capacitor parts at the same time.

### TECHNICAL FIELD

The present invention relates to the technical field of electrolyte solution, in particular to an electrolyte solution for an aluminum electrolytic capacitor and an aluminum electrolytic capacitor using the electrolyte solution.

### DESCRIPTION OF THE RELATED ART

In recent years, the service voltage of the on-board power supply and communication equipment has risen increasingly. More and more requirements are imposed on electrolyte solutions for manufacturing the aluminum electrolytic capacitors, in particular chip capacitors, to improve the specific conductivity on the basis of the current value 4 mS/cm and improve the sparking voltage at the same time.

As the electrolyte solutions for manufacturing the aluminum electrolytic capacitors, a know electrolyte solution is the electrolyte solution containing the electrolyte consisting of aluminum fluoroaluminate and the organic solvent (Japanese Patent Application 2003-142346). The electrolyte solution ensures high sparking voltage, but has the following problem that the aluminum fluoroaluminate is hydrolyzed to generate hydrogen fluoride which corrodes the aluminum oxide serving as the anode foil of the electrolytic capacitor.

Another known electrolyte solution is the electrolyte solution containing the electrolyte consisting of the alkyl phosphate anions and the organic solvents. The electrolyte solution uses the alkyl phosphate anions as the electrolyte anions, wherein the electrolyte anions may be a single type of alkyl phosphate anions or mixed alkyl phosphate anions. Substantially, the electrolyte solution is an electrolyte solution only containing a single type of electrolyte alkyl phosphate anions. The electrolyte solution does not have the problem of corroding the anode foil of the electrolytic capacitors, but also has defects of low specific conductivity and sparking voltage.

### BRIEF SUMMARY OF THE INVENTION

The present invention relates to an electrolyte solution for an aluminum electrolytic capacitor and an aluminum electrolytic capacitor using the electrolyte solution, which effectively improves specific conductivity and ensures high sparking voltage.

On the one hand, the present invention provides an electrolyte solution for an aluminum electrolytic capacitor. The electrolyte solution contains electrolyte (A) and an organic solvent (B). The electrolyte (A) contains electrolyte (C) and electrolyte (D); the electrolyte (C) consists of cations (E) and alkyl phosphate anions, and the electrolyte (D) consists of cations (F) and phthalic acid anions.

On the other hand, the present invention provides an aluminum electrolytic capacitor. The aluminum electrolytic capacitor is formed by using the above electrolyte solution.

The electrolyte in the electrolyte solution of the present invention contains the alkyl phosphate anions and the phthalic acid anions at the same time, can acquire high electric conductivity and sparking voltage. Particularly, compared with the electrolyte solution with the single element of alkyl phosphate anions, the present invention has higher electric conductivity and the sparking voltage. The electrolyte solution of the present invention can realize aluminum electrolytic capacitor without a risk of corrosion of capacitor parts. Therefore, those capacitors have a huge market potential in the competition of the high-voltage-withstanding products using power supplies on the market.

### DETAILED DESCRIPTION OF THE PRESENT INVENTION

The present invention is described in further detail with reference to the attached embodiments.

One of key concept of the present invention lies in that, an electrolyte containing alkyl phosphate cations and an electrolyte containing phthalic acid anions are mixed as the electrolyte element of the electrolyte solution for an aluminum electrolytic capacitor. It is surprised to find that, the mixed electrolytes of the present invention has higher electric conductivity and ensures higher sparking voltage in comparison with single electrolyte element (namely the electrolyte containing alkyl phosphate cations or the electrolyte containing phthalic acid anions), which represents that the alkyl phosphate cations and phthalic acid anions in the electrolyte of the present invention generate a good synergistic effect.

In one embodiment of the present invention, an electrolyte solution contains electrolyte (A) and an organic solvent (B). The electrolyte (A) contains electrolyte (C) and electrolyte (D); the electrolyte (C) consists of cations (E) and alkyl phosphate anions, and the electrolyte (D) consists of cations (F) and phthalic acid anions.

In the above solution, the content of the electrolyte (C) is preferably 10%˜65% based on the weights of the electrolyte (C) and the organic solvent (B), for example, 10.2%, 11%, 12%, 12.5%, 13.5%, 14.5%, 15%, 18%, 18.5%, 20.5%, 22.5%, 25%, 28%, 30%, 32%, 35%, 38%, 40%, 42%, 45%, 47%, 50%, 52%, 55%, 56%, 58%, 60%, 62%, 63.5%, 64.5% or 64.8%, more preferably 15%˜45%, and most preferably 18.5%˜25.5%.

In the above solution, the content of the electrolyte (D) is preferably 1%˜35% based on the weights of the electrolyte (A) and the organic solvent (B), for example, 1.2%, 1.5%, 1.8%, 2%, 2.5%, 4%, 5%, 6%, 7%, 8%, 10%, 12%, 12.5%, 15%, 18%, 20%, 22.5%, 25%, 26%, 28%, 30%, 31.5%, 32%, 33%, 33.5%, 34%, 34.5% or 34.8%, more preferably 5%˜30%, and most preferably 15.5˜25.5%.

In the above embodiment, the cations (E) and the cations (F) are respectively independently selected from amidine onium cations or quaternary ammonium salt cations.

Amidine onium cations contain (1) imidazole cations and (2) imidazolium cations.

(1) Imidazole Cations

1,2,3,4-methylimidazole, 1,3,4-trimethyl-2-ethylimidazole, 1,3-dimethyl-2,4-diethylimidazole, 1,2-dimethyl-3,4-diethylimidazole, 1-methyl-2,3,4-triethylimidazole,1,2,3,4-tetraethylimidazole, 1-ethyl-2,3-dimethylimidazol, 1,3-dimethyl-2-ethylimidazole, 4-cyan-1,2,3-trimethylimidazole, 3-cyanomethyl-1,2-dimethylimidazol, 2-cyanomethyl-1,3-dimethylimidazol, 4-acetyl-1,2,3-trimethylimidazole, 3-acetylmethyl-1,2-dimethylimidazol, 4-acetyl-1,2,3-trimethylimidazole, 3-acetylmethyl-1,2-dimethylimidazol, 4-methyl carboxyl methyl-1,2,3-trimethylimidazole, 3-methyl carboxyl methyl-1,2-dimethylimidazol, 4-methoxy-1,2,3-trimethylimidazole, 3-methyl carboxyl methyl-1,2-dimethylimidazol, 4-formyl-1,2,3-trimethylimidazole, 3-formylmethyl-1,2-dimethylimidazol, 3-hydroxyethyl-1,2-dimethylimidazol, 4-hydroxymethyl -1,2,3-trimethylimidazole, 2-hydroxyethyl-1,3-dimethylimidazol, etc.

(2) Imidazolium Cations

1,3-dimethylimidazolium, 1,3-diethylimidazolium, 1-ethyl-3-methylimidazolium, 1,2,3-trimethylimidazolium, 1,2,3,4-tetramethylimidazolium, 1,3-dimethyl-2-ethylimidazolium, 1-ethyl-2,3-dimethylimidazolium, 1,2,3-triethylimidazolium, 1,2,3,4-tetraethylimidazolium, 1,3-dimethyl-2-phenylimidazolium, 1,3-dimethyl-2-benzylimidazolium, 1-benzyl-2,3-dimethylimidazolium, 4-cyano-1,2,3-trimethylimidazolium, 3-cyanomethyl-1,2-dimethylimidazolium, 2-cyanomethyl-1,3-dimethylimidazolium, 4-acetyl-1,2,3-trimethylimidazolium, 3-acetylmethyl-1,2-dimethylimidazolium, 4-methyl carboxyl methyl-1,2,3-trimethylimidazolium, 3-methyl carboxyl methyl-1,2-dimethylimidazolium, 4-methoxy-1,2,3-trimethylimidazolium, 3-formylmethyl-1,2-dimethylimidazolium, 3-hydroxyethyl-1,2-dimethylimidazolium, 4-hydroxymethyl-1,2,3-trimethylimidazolium, 2-hydroxyethyl-1,3-dimethylimidazolium, etc.

(3) Quaternary Ammonium Salt Cations

Quaternary ammonium salt may be tetra-allkylammonium cations with 1-4 carbon atoms (for example, tetramethyl-ammonium, tetraethyl-ammonium, triethylmethyl-ammonium, etc.)

The above amidine onium cations can be used independently or in a mixed way. The amidine onium cations are preferably 1,2,3,4-tetramethylimidazolium cations or 1-ethyl-3-methylimidazolium cations.

The cations (E) for forming the electrolyte (C) and the cations (F) for forming the electrolyte (D) may be the same, or different. In a preferable embodiment of the present invention, the cations (E) and the cations (F) are the same, and it is found that, better effect is obtained in the case that the cations (E) and the cations (F) are the same in comparison with the case that cations (E) and the cations (F) are different.

In the above embodiment, the carbon number of alkyl of the alkyl phosphate anions is1-10, and preferably 1-4. It should be noted that the smaller the carbon number is, the higher the electric conductivity and the sparking voltage are.

The alkyl phosphate anions may be monoalkyl phosphate or dialkyl phosphate.

The monoalkyl phosphate may be monomethyl phosphate, monoethyl phosphate, monopropyl phosphate [mono(n-propyl) phosphate, mono (isopropyl) phosphate], monobutyl phosphate[mono (n-butyl) phosphate, mono (isobutyl) phosphate], monoamyl phosphate, monohexyl phosphate, etc.

The dialkyl phosphate may be dimethyl phosphate, diethyl phosphate, dipropyl phosphate [di(n-propyl) phosphate, di (isopropyl) phosphate], dibutyl phosphate[di (n-butyl) phosphate, di(isobutyl) phosphate], diamyl phosphate, dihexyl phosphate, etc.

The above alkyl phosphate anions can be used independently or in a mixed way, or may be mixtures of the monoalkyl phosphate and the dialkyl phosphate. As an optimization of the embodiment of the present invention, the alkyl phosphate anions may be diethyl phosphate anions or dimethyl phosphate anions.

In the present invention, the electrolyte (C) containing the alkyl phosphate anions can be synthesized by the following process. First, the imidazoline or the quaternary ammonium salt is dissolved in methanol solution, and under certain conditions, reacts with dimethyl carbonate to generate imidazole (or quaternary ammonium) dimethyl carbonate acetate; then, alkyl phosphatase acetate is added to perform the exchange reaction with the methanol solution of the salt obtained in the above step so as to obtain imidazole (or quaternary ammonium) alkyl phosphate; finally, the electrolyte containing alkyl phosphate is obtained through a series of purification by rectification.

In the present invention, the electrolyte (D) containing the phthalic acid anions can be synthesized by the following process. The following process is similar to the above process. First,the imidazoline or the quaternary ammonium salt is dissolved in methanol solution, and under certain conditions, reacts with dimethyl carbonate to generate imidazole (or quaternary ammonium) dimethyl carbonate; then, phthalic acid is added to perform the exchange reaction with the methanol solution of the salt obtained in the above step so as to obtain imidazole (or quaternary ammonium) phthalate; finally, the electrolyte containing phthalic acid is obtained through a series of purification by rectification.

In the above embodiment, the organic solvent (B) may be selected from (1) alcohol, (2) ester, (3) amide, (4) internal ester, (5) nitrile, (6) carbonic ester, (7) sulphone and (8) other organic solvents.

(1) Alcohol

Monohydric alcohol (for example, methanol, ethanol, propanol, butanol, diacetone alcohol, benzyl alcohol, alkamine, sugar alcohol, etc.), dihydric alcohol (for example, ethylene glycol, propylene glycol, diethylene glycol, hexylene glycol, etc.), trihydric alcohol (for example, glycerol, etc.), and tetrahydric alcohol and above (for example, hexitol, etc.)

(2) Ether

Monoether (for example, ethylene glycol monomethyl ether, ethylene glycol monoethyl ether, ethylene glycol monophenyl ether, tetrahydrofuran, 3-methyltetrahydrofuran, etc.), diether (for example ethylene glycol dimethyl ether, ethylene glycol diethyl ether, diglycol monomethyl ether, diglycol monoethyl ether, etc.), triester (for example, diglycol dimethyl ether, diglycol diethyl ether, etc.).

(3) Amide

Formamide (for example, N-methylformamide, N,N-dimethyl formamide, N-ethyl-formamide, N,N-diethyl formamide), acetamide (for example, N-methylacetamide, N,N-diethylacetamide, etc.), propanamide (for example, N,N-dimethylpropionamide, etc.), pyrrolidone (for example, N-methyl pyrrolidinone, N-ethyl pyrrolidinone), hexamethyl ammonium phosphate.

(4) Inner Ester

γ-butyrolactone (hereinafter referred to as GBL), α-acetyl-γ-butyrolactone, β-butyrolactone, γ-valerolactone, δ-valerolactone, etc.

(5) Nitrile

Acetonitrile, propionitrile, butyronitrile, acrylonitrile, methacrylonitrile, cyanophenyl,etc. (6) Carbonic Ester

Ethylene carbonate, propylene carbonate, butylene carbonate, dimethyl carbonate, diethyl carbonate, etc.

(7) Sulphone

Sulfolane, dimethyl sulfoxide, dimethyl sulfone, etc.

(8) Other Solvents

1,3-dimethyl-2-imidazolone, aromatic solvents (for example, methylbenzene, xylene, etc.), alkane solvents (for example, normal paraffin, isoparaffin, etc.)

The above organic solvents can be used independently or in a mixed way. The organic solvents are preferably alcohol, inner ester and sulphone, and more preferably γ-butyrolactone, sulfolane or ethylene glycol.

In the above solution, the content of the organic solvent (B) is preferably 30%˜85% based on the weights of the electrolyte (A) and the organic solvent (B), for example, 30.5%, 32%, 33.5%, 35%, 36%, 40%, 41.5%, 42%, 43.5%, 45%, 47%, 48%, 50%, 52%, 55%, 56%, 57.5%, 58%, 60%, 62.5%, 64%, 65%, 67.5%, 70%, 72%, 75%, 78%, 80%, 82%, 83%, 84.5% or 84.8%, more preferably 45%˜75%, and most preferably 55%˜65.5%.

As a further improved technical solution of the present invention, the electrolyte also contains additives. The additives are selected from at least one of o-nitrobenzoic acid, p-nitrobenzoic acid, m-nitrobenzoic acid, o-nitrophenol, p-nitrophenol, p-nitrobenzyl alcohol and m-nitroacetophenon. Those additives can improve the hydrogen absorption effect of the electrolyte itself and can effectively prevent the manufactured capacitor from bossing at the bottom, etc. It should be noted that, the electrolyte of the present invention can contain additives, or not contain the additives. Considering improvement of the hydrogen absorption effect of the electrolyte, the above additives can be added.

As an additive, the content is preferably 0.1˜3% based on the weighs of the electrolyte (A) and the organic solvent (B), for example, 0.12%, 0.15%, 0.18%, 0.2%, 0.25%, 0.3%, 0.4%, 0.5%, 0.8%, 0.9%, 1%, 1.2%, 1.3%, 1.5%, 1.8%, 2.0%, 2.2%, 2.3%, 2.4%, 2.5%, 2.8%, 2.85%, 2.95% or 2.98%, more preferably 0.5%˜2.5%, and most preferably 0.8%˜1.3%.

In the present invention, the content of all ingredients is 100% based on the weights of the electrolyte (A) and the organic solvent (B).

The present invention also provides an aluminum electrolytic capacitor formed by using the electrolyte solution in the above embodiment, preferably an aluminum electrolytic capacitor of γ-butyrolactone system.

The following are specific embodiments of the present invention. Those skilled in this field should understand that the following embodiments are exemplary, and that the present invention is not limited to the following embodiments.

### Embodiment 1

The methanol solution of the dimethyl carbonate is dropped with 2,4-dimethyl imidazoline; the mixed solution is stirred for 48 h at a temperature of 100° C. to obtain the methanol solution of 1,2,3,4-tetramethylimidazolium dimethyl carbonate.

Triethyl phosphate is added into methanol solution of 1,2,3,4-tetramethylimidazolium dimethyl carbonate to perform salt exchange reaction, and then the methnoal solution of the 1,2,3,4-tetramethylimidazolium diethyl phosphate anions is obtained. The obtained solution is heated and stilled to generate methanol at a reduced pressure of below 1.0 kPa and a temperature of below 50° C. until no methanol is obtained. Then, the solution is heated for 30 min such that the temperature slowly raises from 50° C. to 100° C. to generate mono-methyl carbonate ester (HOCO₂CH₃), methanol and carbon dioxide. Thus, the electrolyte 1 is obtained.

Phthalic acid is added into methanol solution of 1,2,3,4-tetramethylimidazolium dimethyl carbonate to perform salt exchange reaction, and then the methnoal solution of the 1,2,3,4-tetramethylimidazolium phthalate is obtained. The obtained solution is heated and stilled to generate methanol at a reduced pressure of below 1.0 kPa and a temperature of below 50° C. until no methanol is obtained. Then, the solution is heated for 30 min such that the temperature slowly rises from 50° C. to 100° C. to generate mono-methyl carbonate ester, methanol and carbon dioxide. Thus, the electrolyte 2 is obtained.

25 g electrolyte 1 and 25 g electrolyte2 are respectively dissolved in 75 g organic solvent 1 (including 60 g GBL and 15 g ethylene glycol) and 75 g organic solvent 2 (GBL) to prepare solution 1 and solution 2; then, 5 g solution 2 is uniformly mixed with 100 g solution 1 to obtain experimental solution 1 with a moisture content of 0.1 wt %.

### Embodiment 2

The methanol solution of the dimethyl carbonate is dropped with 1-ethyl-3-methylimidazolium; the mixed solution is stirred for 48 h at a temperature of 100° C. to obtain the methanol solution of 1-ethyl-3-methylimidazolium dimethyl carbonate.

Then, 1-ethyl-3-methylimidazolium dimethyl carbonate is used to replace the 1,2,3,4-tetramethylimidazolium dimethyl carbonate in embodiment 1 to respectively perform the slat exchange reaction with triethyl phosphate and the phthalic acid to obtain 1-ethyl-3-methylimidazolium diethyl phosphate cations and 1-ethyl-3-methylimidazolium phthalate which are respectively used as the electrolyte 3 and the electrolyte 4.

25 g electrolyte 3 and 25 g electrolyte 4 are respectively dissolved in 75 g organic solvent 1 (including 60 g GBL and 15 g ethylene glycol) and 75 g organic solvent 2 (GBL) to prepare solution 3 and solution 4; then, 5 g solution 4 is uniformly mixed with 100 g solution 3 to obtain experimental solution 2 with a moisture content of 0.1 wt %.

### Embodiment 3

25 g electrolyte 1 synthesized in embodiment 1 and 25 g electrolyte 4 synthesized in embodiment 2 respectively dissolved in 75 g organic solvent 1 (including 60 g GBL and 15 g ethylene glycol) and 75 g organic solvent 2 (GBL) to prepare solution 1 and solution 4; then, 5 g solution 4 is uniformly mixed with 100 g solution 1 to obtain experimental solution 3 with a moisture content of 0.1 wt %.

### Embodiment 4

25 g electrolyte 3 synthesized in embodiment 2 and 25 g electrolyte 2 synthesized in embodiment 1 are respectively dissolved in 75 g organic solvent 1 (including 60 g GBL and 15 g ethylene glycol) and 75 g organic solvent 2 (GBL) to prepare solution 3 and solution 2; then, 5 g solution 2 is uniformly mixed with 100 g solution 3 to obtain experimental solution 4 with a moisture content of 0.1 wt %.

### Embodiment 5

25 g electrolyte 1 synthesized in embodiment 1 and 25 g electrolyte 2 synthesized in embodiment 1 are respectively dissolved in 75 g organic solvent 1 (including 60 g GBL and 15 g ethylene glycol) and 75 g organic solvent 2 (GBL) to prepare solution 1 and solution 2; then, 5 g solution 2 is uniformly mixed with 100 g solution 1, and 1 g p-nitrobenzoic acid is added to obtain experimental solution 6 with a moisture content of 0.1 wt %.

### Embodiment 6

25 g electrolyte 1 synthesized in embodiment 1 and 25 g electrolyte 2 synthesized in embodiment 1 are respectively dissolved in 75 g organic solvent 1 (including 60 g GBL and 15 g ethylene glycol) and 75 g organic solvent 2 (GBL) to prepare solution 1 and solution 2; then, 5 g solution 2 is uniformly mixed with 100 g solution 1, and 1 g p-nitrobenzyl alcohol and 1 g m-nitroacetophenon are added to obtain experimental solution 6 with a moisture content of 0.1 wt %.

### Embodiment 7

Then, trimethyl carbonate is used to replace the triethyl carbonate in embodiment 1 to perform the slat exchange reaction with the methanol solution of 1,2,3,4-tetramethylimidazolium dimethyl carbonate to obtain 1,2,3,4-tetramethylimidazolium dimethyl phosphate which is used as electrolyte 5.

25 g electrolyte 5 and 25 g electrolyte 2 synthesized in embodiment 1 are respectively dissolved in 75 g organic solvent 1 (including 60 g GBL and 15 g ethylene glycol) and 75 g organic solvent 2 (GBL) to prepare solution 5 and solution 2; then, 5 g solution 2 is uniformly mixed with 100 g solution 5 to obtain experimental solution 7 with a moisture content of 0.1 wt %.

### Embodiment 8

Then, trimethyl phosphate is used to replace the triethyl phosphate in embodiment 2 to perform the slat exchange reaction with the methanol solution of 1-ethyl-3-methylimidazolium dimethyl carbonate to obtain 1-ethyl-3-methylimidazolium dimethyl phosphate which is used as electrolyte 6.

25 g electrolyte 6 and 25 g electrolyte 4 synthesized in embodiment 2 are respectively dissolved in 75 g organic solvent 1 (including 60 g GBL and 15 g ethylene glycol) and 75 g organic solvent 2 (GBL) to prepare solution 6 and solution 4; then, 5 g solution 4 is uniformly mixed with 100 g solution 6 to obtain experimental solution 8 with a moisture content of 0.1 wt %.

### Embodiment 9

25 g electrolyte 1 synthesized in embodiment 1 and 25 g electrolyte 2 synthesized in embodiment 1 are respectively dissolved in 75 g organic solvent 1 (including 60 g GBL and 15 g ethylene glycol) and 75 g organic solvent 2 (GBL) to prepare solution 1 and solution 2; then, 10 g solution 2 is uniformly mixed with 95 g solution 1 to obtain experimental solution 9 with a moisture content of 0.1 wt %.

### Embodiment 10

25 g electrolyte 1 synthesized in embodiment 1 and 25 g electrolyte 2 synthesized in embodiment 1 are respectively dissolved in 75 g organic solvent 1 (including 60 g GBL and 15 g ethylene glycol) and 75 g organic solvent 2 (GBL) to prepare solution 1 and solution 2; then, 20 g solution 2 is uniformly mixed with 85 g solution 1 to obtain experimental solution 10 with a moisture content of 0.1 wt %.

### Embodiment 11

25 g electrolyte 1 synthesized in embodiment 1 and 25 g electrolyte 2 synthesized in embodiment 1 are respectively dissolved in 75 g organic solvent 1 (including 60 g GBL and 15 g ethylene glycol) and 75 g organic solvent 2 (GBL) to prepare solution 1 and solution 2; then, 30 g solution 2 is uniformly mixed with 75 g solution 1 to obtain experimental solution 11 with a moisture content of 0.1 wt %.

### Embodiment 12

25 g electrolyte 1 synthesized in embodiment 1 and 25 g electrolyte 2 synthesized in embodiment 1 are respectively dissolved in 75 g organic solvent 1 (including 60 g GBL and 15 g ethylene glycol) and 75 g organic solvent 2 (GBL) to prepare solution 1 and solution 2; then, 40 g solution 2 is uniformly mixed with 65 g solution 1 to obtain experimental solution 12 with a moisture content of 0.1 wt %.

### Embodiment 13

25 g electrolyte 1 synthesized in embodiment 1 and 25 g electrolyte 2 synthesized in embodiment 1 are respectively dissolved in 75 g organic solvent 1 (including 60 g GBL and 15 g ethylene glycol) and 75 g organic solvent 2 (GBL) to prepare solution 1 and solution 2; then, 50 g solution 2 is uniformly mixed with 55 g solution 1 to obtain experimental solution 13 with a moisture content of 0.1 wt %.

### Embodiment 14

40 g electrolyte 1 synthesized in embodiment 1 and 40 g electrolyte 2 synthesized in embodiment 1 are respectively dissolved in 60 g organic solvent 1 (including 60 g GBL and 15 g ethylene glycol) and 60 g organic solvent 2 (GBL) to prepare solution 7 and solution 8; then, 60 g solution 8 is uniformly mixed with 45 g solution 7 to obtain experimental solution 14 with a moisture content of 0.1 wt %.

### Embodiment 15

40 g electrolyte 1 synthesized in embodiment 1 and 40 g electrolyte 2 synthesized in embodiment 1 are respectively dissolved in 60 g organic solvent 1 (including 60 g GBL and 15 g ethylene glycol) and 60 g organic solvent 2 (GBL) to prepare solution 7 and solution 8; then, 25 g solution 8 is uniformly mixed with 80 g solution 7 to obtain experimental solution 15 with a moisture content of 0.1 wt %.

### CONTRAST EXAMPLE 1

12 g electrolyte 2 synthesized in embodiment 1 is dissolved in 88 g organic solvent 2 (GBL) to obtain comparative electrolyte solution 1 with a moisture content of 0.1 wt %.

### CONTRAST EXAMPLE 2

12 g electrolyte 4 synthesized in embodiment 2 is dissolved in 88 g organic solvent 2 (GBL) to obtain comparative electrolyte solution 2 with a moisture content of 0.1 wt %.

### CONTRAST EXAMPLE 3

25 g electrolyte 1 synthesized in embodiment 1 is dissolved in 75 g organic solvent 1 (including 60 g GBL and 15 g ethylene glycol) to obtain comparative electrolyte solution 3 with a moisture content of 0.1 wt %.

### CONTRAST EXAMPLE 4

25 g electrolyte 3 synthesized in embodiment 2 is dissolved in 75 g organic solvent 1 (including 60 g GBL and 15 g ethylene glycol) to obtain comparative electrolyte solution 4 with a moisture content of 0.1 wt %.

For the electrolytes obtained in Embodiments 1-15 and Contrast Examples 1-4, the specific conductivity and sparking voltages were measured, and the results can be seen in table 1.

Specific conductivity: a DJS-1C platinum black conductivity meter was used to measure to the specific conductivity at a temperature of 30° C.

Sparking voltage: a high-voltage forming etched aluminum foil with an area of 10 cm² was used at the anode, while a plane of aluminum foil with an area of 10 cm² was used at the cathode to measure the discharging voltage of the electrolyte solution by using a load-fix-current (30 mA) at a temperature of 30° C.

Moisture test: In accordance with GB/T6283, the moisture test was made by using the Karl Fisher method.

The electrolyte solutions obtained in Embodiments 1-15 and Contrast Examples 1-4 were used to manufacture guide pin type aluminum electrolytic capacitors (rated voltage 100 WV, static capacitance 100 μF; dimension: Φ100 mm×L20 mm)

Load tests were performed on the manufactured aluminum electrolytic capacitors to respectively measure the initial value, tangent value (tanδ) of the loss angle after the capacitors were placed at a temperature of 115° C. for 2,000 h, and the leak current (LC). The results were recorded in table 1.

TABLE 1

| | Property | | | | | | | |
|---|---|---|---|---|---|---|---|---|
| | Specific | Sparking | | | | | | |
| | conductivity | voltage | C μF | | tanδ % | | LC μF | |
| Embodiment | mS/cm | V | 0 h | 2,000 h | 0 h | 2,000 h | 0 h | 2,000 h |
| Embodiment 1 | 9.4 | 296 | 87.9 | 86.8 | 4.66 | 4.91 | 11.47 | 12.36 |
| Embodiment 2 | 8.4 | 190 | 87.8 | 86.1 | 4.89 | 5.68 | 11.58 | 12.26 |
| Embodiment 3 | 7.7 | 207 | 87.6 | 86.8 | 5.15 | 6.05 | 12.03 | 12.54 |
| Embodiment 4 | 7.2 | 253 | 86.8 | 85.8 | 6.02 | 7.06 | 12.28 | 13.56 |
| Embodiment 5 | 7.9 | 282 | 87.3 | 86.4 | 4.55 | 4.83 | 11.32 | 12.32 |
| Embodiment 6 | 9.2 | 293 | 87.6 | 86.5 | 4.35 | 4.89 | 11.21 | 12.02 |
| Embodiment 7 | 8.9 | 303 | 87.6 | 86.4 | 4.70 | 4.90 | 11.51 | 12.40 |
| Embodiment 8 | 8 | 186 | 87.1 | 86.7 | 4.64 | 5.68 | 11.55 | 12.32 |
| Embodiment 9 | 9.3 | 263 | 87.1 | 86.5 | 4.71 | 4.88 | 11.50 | 12.40 |
| Embodiment 10 | 9.2 | 231 | 87.5 | 86.7 | 4.65 | 5.68 | 11.51 | 12.35 |
| Embodiment 11 | 9.1 | 199 | 87.3 | 86.6 | 4.71 | 4.90 | 11.53 | 13.81 |
| Embodiment 12 | 9 | 184 | 87.4 | 86.9 | 4.66 | 5.69 | 11.55 | 14.58 |
| Embodiment 13 | 8.9 | 170 | 86.9 | 86.4 | 4.72 | 4.87 | 11.54 | 15.86 |
| Embodiment 14 | 8.8 | 161 | 87.1 | 86.5 | 4.68 | 5.37 | 11.58 | 16.33 |
| Embodiment 15 | 8.8 | 153 | 87.2 | 86.3 | 4.62 | 5.28 | 11.59 | 16.56 |
| Contrast Example 1 | 3.5 | 150 | 87.8 | 86.9 | 6.28 | 7.32 | 14.19 | 15.35 |
| Contrast Example 2 | 3.3 | 137 | 87.8 | 85.7 | 6.26 | 7.56 | 14.60 | 15.68 |
| Contrast Example 3 | 7.1 | 182 | 87.6 | 86.8 | 5.69 | 6.55 | 12.03 | 12.54 |
| Contrast Example 4 | 6.5 | 178 | 86.8 | 85.8 | 5.49 | 7.16 | 12.28 | 13.56 |

The results in table 1 show that, the electrolyte prepared in the embodiments of the present invention can maintain the specific conductivity at a level of over 8 mS/cm at a temperature of 30° C., and ensure that the sparking voltage is high enough.

The results in the Contrast Examples 1 and 2 show that, the electrolyte solution prepared by using the single phthalate as the electrolyte anions has relatively low specific conductivity and sparking voltage, and the anode foil tends to short-circuit at a 100 WV rated voltage, thus resulting in increase in the loss angle of the capacitors and leak current, and seriously affecting the service life of the capacitors.

The results in the Contrast Examples 3 and 4 show that, the electrolyte solution prepared by using the single alkyl phosphate salt as the electrolyte anions has relatively low specific conductivity and sparking voltage in comparison with the electrolyte solutions prepared by using the mixed salts as the electrolyte anions.

The results represent that the alkyl phosphate and the phthalic acid anions in the present invention which coexist in the electrolyte solution achieve a good synergistic effect, can effectively improve the specific conductivity and ensure high sparking voltage at the same time.

The test results in Embodiments 3 and 4 show that, the specific conductivity of the electrolyte solution prepared by using the mixed cations as the electrolyte cations is about 7.2-7.7 mS/cm at the temperature of 30° C., lower than that the specific conductivity of electrolyte solutions prepared by using single type of cations. This proves that the electrolyte solutions prepared by using single type of cations are better.

The test results in Embodiments 5 and 6 show that, using the additives (hydrogen elimination agent) generates certain influences on the specific conductivity of the electrolyte, wherein adding nitrobenzoic acid changed the PH value of the electrolyte solution, and the specific conductivity is lowered. However, the electrolyte solutions in Embodiments 5 and 6 also have high specific conductivity and can meet the requirements for use of the capacitors.

In conclusion, the electrolyte solution of the present invention can obtain high specific conductivity and sparking voltage, and can realize aluminum electrolytic capacitor without a risk of corrosion of capacitor parts. Therefore, those capacitors have a huge market potential in the competition of the high-voltage-withstanding products using power supplies on the market.

1. An electrolyte solution for an aluminum electrolytic capacitor, characterized in that, the electrolyte solution contains electrolyte (A) and an organic solvent (B); the electrolyte (A) contains electrolyte (C) and electrolyte (D); the electrolyte (C) consists of cations (E) and alkyl phosphate anions, and the electrolyte (D) consists of cations (F) and phthalic acid anions.

2. The electrolyte solution according to claim 1, characterized in that, the content of the electrolyte (C) is preferably 10%˜65% based on the weights of the electrolyte (A) and the organic solvent (B), preferably 15%˜45%, and more preferably 18.5%˜25.5%.

3. The electrolyte solution according to claim 1, characterized in that, the content of the electrolyte (D) is preferably 1%˜35% based on the weights of the electrolyte (A) and the organic solvent (B), preferably 5%˜30%, and more preferably 15.5%˜25.5%.

4. The electrolyte solution according to claim 1, characterized in that, the cations (E) and the cations (F) are respectively independently selected from amidine onium cations or quaternary ammonium salt cations;
preferably, the amidine onium cations are preferably 1,2,3,4-tetramethylimidazolium cations or 1-ethyl-3-methylimidazolium cations.

5. The electrolyte solution according to claim 1, characterized in that, the cations (E) and the cations (F) are identical.

6. The electrolyte solution according to claim 1, characterized in that, the carbon number of alkyl of the alkyl phosphate anions is 1-10, and preferably 1-4;
preferably, the alkyl phosphate anions are diethyl phosphate anions or dimethyl phosphate anions.

7. The electrolyte solution according to claim 1, characterized in that, the organic solvent (B) is selected from y-butyrolactone, sulfolane or ethylene glycol;
preferably, the content of the organic solvent (B) is 30%˜85% based on the weights of the electrolyte (A) and the organic solvent (B), preferably 45%˜75%, and more preferably 55%˜65.5%.

8. The electrolyte solution according to claim 1, characterized in that, the electrolyte also contains additives; and the additives are selected from at least one of o-nitrobenzoic acid, p-nitrobenzoic acid, m-nitrobenzoic acid, o-nitrophenol, p-nitrophenol, p-nitrobenzyl alcohol and m-nitroacetophenon;
preferably, the content of the additive is 0.1˜3% based on the weights of the electrolyte (A) and the organic solvent (B), preferably 0.5%˜2.5%, and more preferably 0.8%˜1.3%.

9. An aluminum electrolytic capacitor, characterized in that, the aluminum electrolytic capacitor is formed by using the electrolyte solution according to claim 1.

10. The aluminum electrolytic capacitor according to claim 9, characterized in that, the the aluminum electrolytic capacitor is an aluminum electrolytic capacitor of γ-butyrolactone system.
